(19) United States
(12) Patent Application Publication
(10) Pub. No.: US 2005/0203864 A1
(43) Pub. Date: Sep. 15, 2005

(54) System and method for data management

(75) Inventors: Ross A. Schmidt, New Hope, MN (US); Robert M. Craig, Richfield, MN (US); Cameron Black, Burnsville, MN (US); Sean M. Brockway, Minnetonka, MN (US); Todd Partington, Shakopee, MN (US)

Correspondence Address: MERCHANT & GOULD PC, P.O. BOX 2903, MINNEAPOLIS, MN, 55402-0903, US

(73) Assignee: ONTRAK DATA INTERNATIONAL, INC., Eden Prairie, MN (US)

(21) Appl. No.: 10/941,065

(22) Filed: Sep. 13, 2004

Related U.S. Application Data
(63) Continuation of application No. 09/894,373, filed on Jun. 27, 2001, now abandoned.

(51) Int. Cl. G06F 17/30

(52) U.S. Cl. 707/1

(57) ABSTRACT

An automated data management system and method for logging, processing, and reporting a large volume of data having different file types, using different versions, stored on different media, and/or run by different operating systems, includes a first processor for restoring a plurality of received data files, the data files being capable of being different file types; a file organizing/categorizing processor for organizing the received data files into data slices, each data slice including an identification number and a descriptor that describes characteristics of the received data file; a file logging processor for logging the received data files into a first database based on the data slices; a data uploading processor for uploading the first database to a second database; a de-duplicate processor for calculating a SHA value of the received data files to determine whether the received data files have duplicates and flagging duplicated data files in the second database; an image conversion processor for converting at least a portion of the received data files into image files; and a second processor for exporting the image files.

### FIELD OF THE INVENTION

This present invention relates in general to a data management system and method, and more particularly, to an automated data management system and method for organizing and processing a large volume of various types of data files.

### BACKGROUND OF THE INVENTION

With more and more information being stored electronically, it is found that the information is often stored in different formats, i.e., different types of files, on different storage media, using different versions of applications, or run by different operating systems. For example, some data may be in Microsoft Word format, while other data may be in WordPerfect format. Some data is in Microsoft Excel format, while others are in a variety of formats including, but not limited to, Microsoft Mail, Outlook, GroupWise, Lotus Notes, etc. Further, data may be stored in a hard drive, a floppy disk, a backup tape, a CD, or an optical device, etc. Furthermore, data may be operated by a UNIX, NOVELL, NT, or DOS system, etc.

To review and/or manipulate any of data that are stored in different file types, using different versions, on different media, run by different operating systems, a customer often needs to open/close the corresponding different software programs, such as Word, WordPerfect, Excel, Email Outlook, etc. This is a very inefficient way of reviewing and manipulating the stored data. Further, one has to have these software programs and their updated versions to review and/or manipulate the stored data.

In an area of litigation support, in particular, huge amount of documents and/or exhibits may have to be produced, organized, reviewed, reproduced, etc., for example, in merger and acquisition, intellectual property, anti-trust, and class action cases. The documents and/or exhibits may come from different locations in different file types using different versions. The existing methods of handling documents and/or exhibits include hand-coding or bar-coding. The hand-coding or bar-coding methods are not truly automated methods, and these methods are not efficient particularly in handling a volumetric amount of documents and/or exhibits.

Many litigation support companies often send out huge amounts of electronic documents to a third world developing country or hire scores of temporary workers. These workers would open documents, print documents, and enter information about a document by hand into an organized file. These methods are often time consuming, labor intensive, and prone to human mistakes. The sheer volume of data that one needs to review under strict discovery deadlines becomes a challenging and time demanding task. As a reviewer gathers electronic information, the reviewer is required to be confident that s/he has thoroughly searched, found, and reviewed all of the information residing on laptops, desktops, servers, and backup tapes, and sometimes in multiple locations.

The existing data management systems use data paths, such as data source paths and data destination paths, to organize and/or log or access data files. When one process the data files, s/he has to find the data paths. Further, the number of data paths is limited. For example, to administer and process three data files, i.e. two generated by John Smith at ABC company on Sep. 12, 2000 in its two New York branch offices and one by Jay Smith at ABC company on Sep. 12, 2000 in one of its New York branch offices, the existing data management systems have used the data paths, such as ABC\9/12/2000\NY\JohnSmith\file name; ABC\9/12/2000\JohnSmith\NY2\file name; and ABC\9/12\2000\NY\JaySmith\file name. These data paths closely tie to a specific user, location, etc. The quality and efficiency of processing data files are significantly dependent on a process controller's experience and knowledge of data path structures.

Accordingly, there is a need for an efficient, automated data management system and method for organizing and processing a large volume of various types of data files. Further, improvements on administering and controlling the automated data management process are desired.

It is with respect to these or other considerations that the present invention has been made.

### SUMMARY OF THE INVENTION

In accordance with this invention, the above and other problems were solved by providing an efficient, automated data management system for logging, processing, and reporting a large volume of data capable of being in any types.

In one embodiment, a data management system in accordance with the principles of the present invention provides a data slice which is used to describe and categorize a unique set of data where every data file in that set of data has common characteristics, such as, but not limited to, owner/creator, location, backup date, or data type, etc., that are important in describing and labeling the data files. In other words, a data slice is a label assigned to a set or collection of data, and a data slice generally includes data descriptors or characteristics, such as company, user, date, location, etc. A data slice preferably has an ID number that is stored in a database.

One embodiment of a data management system in accordance with the principles of the present invention includes: a first processor for restoring a plurality of received data files, the data files being capable of being different file types; a file organizing/categorizing processor for organizing the received data files into data slices, each data slice including an identification number and a descriptor that describes characteristics of the received data file; a file logging processor for logging the received data files into a first database based on the data slices; a data uploading processor for uploading the first database to a second database; a de-duplicate processor for calculating a SHA value of the received data files to determine whether the received data files have duplicates and flagging duplicated data files in the second database; an image conversion processor for converting at least a portion of the received data files into image files; and a second processor for exporting the image files.

In one embodiment, the first database is a local database for a specific data slice or a predetermined number of data slices, and the second database is a global database for the data slices in combination. The image files are preferably stored in the global database to be viewed.

Further in one embodiment, the image files that are converted from the data files are in a standardized image format, such as tiff format, PDF format, etc. The image files can then be exported/outputted, e.g. printed, etc.

Yet in one embodiment, the data files are in a variety of formats including, but not limited to, Microsoft Mail, Outlook, GroupWise, Lotus Notes, etc. Also, the data files have a variety of formats including Word, Excel, PowerPoint, and Access. The data files may include an attachment data file, which in turn may contain additional attachment data file. The process is designed to handle an endless number of levels of embedded data files.

Additionally in one embodiment, an attachment data file is generally associated with a data file such that image files for the data file and the corresponding attachment data file can be viewed together.

Still in one embodiment, the file logging processor, the image conversion processor, and the second processor are parallel processors such that the data files are parallel-processed in a data file logging stage, an image conversion stage, and an image file output stage.

Further in one embodiment, the data files having the same file type are preferably converted into the image files together.

Yet in one embodiment, the data management system includes a plurality of image conversion processors, each of the image conversion processors being capable of converting the data files having the same file type into the corresponding image files.

Additionally in one embodiment, the file logging processor identifies the file type of the data files based on the SHA value and a file header of each of the data files.

Still in one embodiment, the data management system may include a keyword search processor for searching a keyword from the received data files or processed image files. The keyword search can be performed either before processing the data files or after processing the data files. If a preprocessing keyword search, i.e. the keyword search is performed before processing the data files, is desired and preformed, and if there is a hit, the corresponding data file that is being searched is retained for processing, and the data file without a hit is discarded without being processed. If a post-processing keyword search, i.e. the keyword search is performed after processing the data files, is desired and performed, and if there is a hit, the corresponding image file is exported, and the image file without a hit is not exported.

The present invention also provides a method of logging, processing, and reporting a large volume of data capable of being in different types.

In one embodiment, the method in accordance with the principles of the present invention includes the steps of: restoring a plurality of received data files, the data files being capable of being different file types; organizing/categorizing the received data files into data slices, each data slice including an identification number and a descriptor that describes characteristics of the received data file; logging the received data files into a first database based on the data slices; uploading the first database to a second database; de-duplicating duplicates in the received data files by calculating a SHA value of the received data files to determine whether the received data files have duplicates and flagging duplicated data files in the database; converting at least a portion of the received data files into image files, respectively; and exporting the image files.

Still in one embodiment, the method further includes the step of viewing the image files stored in the second database.

Further in one embodiment, the converting of the data files includes converting the data files into the corresponding image files in a standardized image format, such as a PDF format, a tiff format, etc.

One of the advantages of the present invention is that the data files are organized and processed in an efficient automated manner. The turn around time for generating a report containing the organized image files is substantially shortened. The quality and efficiency of processing data files are improved.

Another advantage of the present invention is that the duplicates in the data files can be eliminated (i.e. de-duplicating). The size of the entire data files can be substantially reduced.

A further advantage of the present invention is that the parallel processing of the data files allows the processing of the data files to be scalable.

An additional advantage of the present invention is that the converted image files are organized such that it allows readily further processing of the data files.

Yet another advantage of the present invention is that every data file logged associates with a data slice id, which allows the processes, such as de-duplication, image conversion, and image output, to be performed on the data slice level.

These and various other features as well as advantages which characterize the present invention will be apparent from a reading of the following detailed description and a review of the associated drawings.

### BRIEF DESCRIPTION OF THE DRAWINGS

Referring now to the drawings in which like reference numbers represent corresponding parts throughout:

FIG. 1 illustrates a block diagram of one embodiment of a data management system in accordance with the principles of the present invention.

FIG. 2 illustrates an operational flow diagram of an exemplary operation of a data management method in accordance with the principles of the present invention.

FIG. 3 illustrates an operational flow diagram of an exemplary logging data file operation in accordance with the principles of the present invention.

FIG. 4 illustrates an operational flow diagram of an exemplary de-duplicating data file operation in accordance with the principles of the present invention.

FIG. 5 illustrates an operational flow diagram of an exemplary image conversion operation in accordance with the principles of the present invention.

FIG. 6 illustrates an operational flow diagram of an exemplary outputting image file operation in accordance with the principles of the present invention.

FIG. 7 illustrates an operational flow diagram of exemplary operation phases of a data management system in accordance with the principles of the present invention.

FIG. 8 illustrates exemplary data files and their corresponding organized data slices in accordance with a preferred embodiment of the present invention.

### DETAILED DESCRIPTION OF THE PREFERRED EMBODIMENTS OF THE INVENTION

The present invention discloses an efficient, automated data management system for logging, processing, and reporting a large volume of data capable of being in different types, using different versions, stored on different media, and/or run by different operating systems.

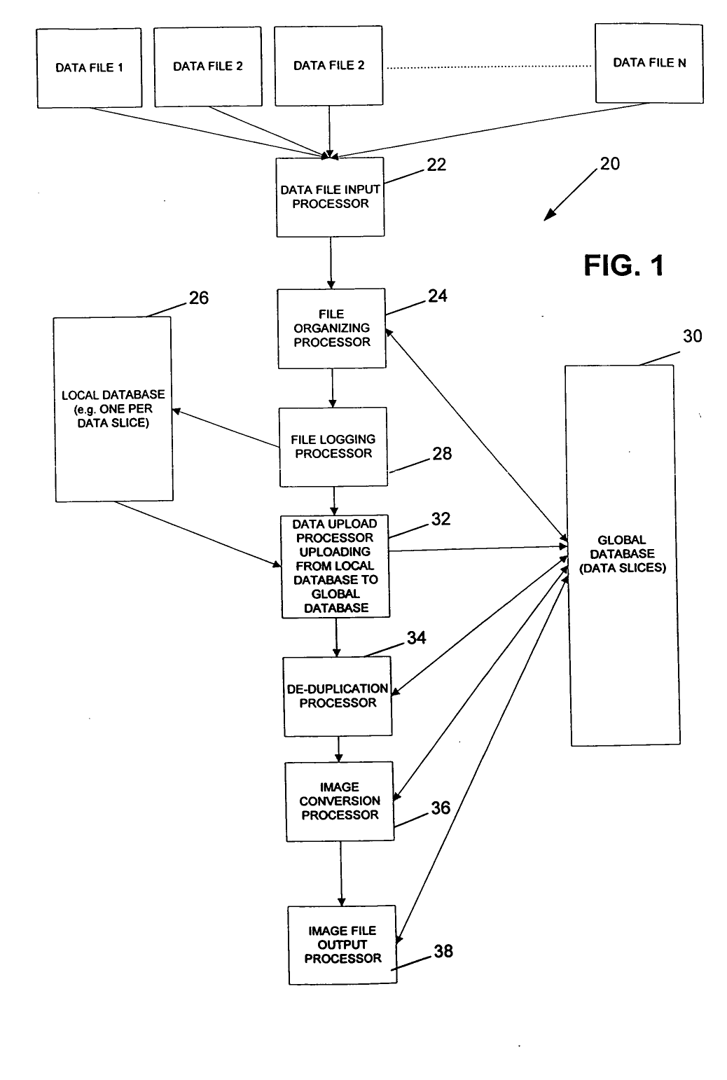

A preferred embodiment of a data management system 20 in accordance with the principles of the present invention is shown in FIG. 1. A plurality of data files N are imported into a data file input processor 22. The data files are organized by a file organizing/categorizing processor 24 into data slices. Each data slice includes an identification number and a descriptor. A descriptor describes characteristics of a received data file. Data slice is a term of art that is used to describe and categorize a unique set of data where every data file in that set of data has common characteristics, such as, but not limited to, owner/creator, location, backup date, data type, or etc. These characteristics are generally considered to be important in describing and labeling the data files. In other words, a data slice is a label assigned to a set or collection of data, and a data slice generally includes a data descriptor or characteristics, such as company, user, date, location, etc. A data slice preferably has an ID number that is stored in a database.

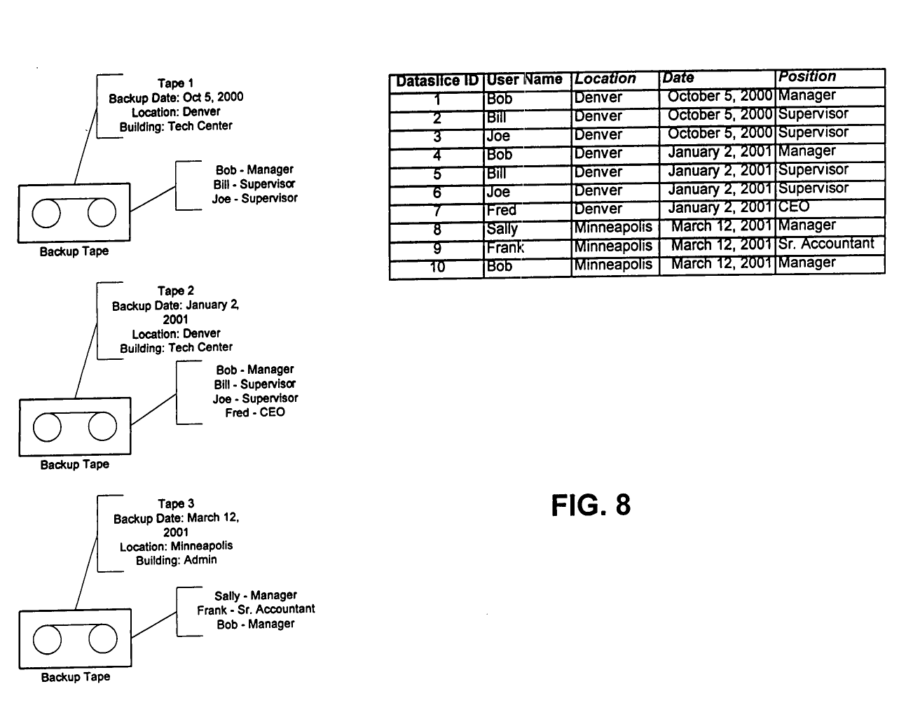

An example of a data slice structure or database is shown in FIG. 8. There are ten data files. Three data files are generated by Bob (Manager), Bill (Supervisor), and Joe (Supervisor), respectively, and backed up on Oct. 5, 2000 at the Tech Center in Denver. These data files are stored on a backup tape 1. Four data files are generated by Bob (Manager), Bill (Supervisor), Joe (Supervisor), and Fred (CEO), respectively, and backed up on Jan. 2, 2001 at the Tech Center in Denver. These four data files are stored on a backup tape 2. The last three data files are generated by Sally (Manager), Frank (Sr. Accountant), and Bob (Manager), respectively, and backed up on Mar. 12, 2001 at the Administration Office in Minneapolis. These three data files are stored on a backup tape 3. A data slice is assigned to each data file with a unique data slice ID and a descriptor. The descriptor includes, but not limited to, the person's name, location, data, and the person's position in the company, etc. The data slices are logged into a database such as the one shown in FIG. 8.

As shown in FIG. 1, data files are first logged into a local database 26 by a file logging processor 28 and then uploaded into a global database 30 by a data upload processor 32. The file logging processor 28 also identifies a file type of the data file and stores the file type information of the data file into the local database 26. The file type information is also uploaded into the global database 30 by the data upload processor 32.

A de-duplicate processor 34 is coupled to the data upload processor 32. The de-duplicate processor 34 flags duplicates of the data files, i.e. de-duplicates the data files by creating a unique subset of data files and flagging duplicated files as such and storing this information in the global database 30. Generally, the de-duplicate processor 30 calculates a SHA value of the received data files to determine whether the received data files have duplicates and flags duplicated data files in the global database 30. The data slice structure of the system 20 allows one to have options of de-duplicating the entire database, no de-duplicating at all, or de-duplicating per data slice or a set of data slices.

An image conversion processor 36 is coupled to the de-duplicate processor 34. The image conversion processor 36 converts the data files into image files. The data slice structure of the system 20 allows one to convert the desired data slice.

A data file output processor 38 is coupled to the image conversion processor 36. The data file output processor 38 exports the image files. The data slice structure of the system 20 allows one to have options of exporting the entire converted image files or exporting a set of converted image files. The exporting may include, but not limited to, printing the image files, or sending the image files to a device, etc.

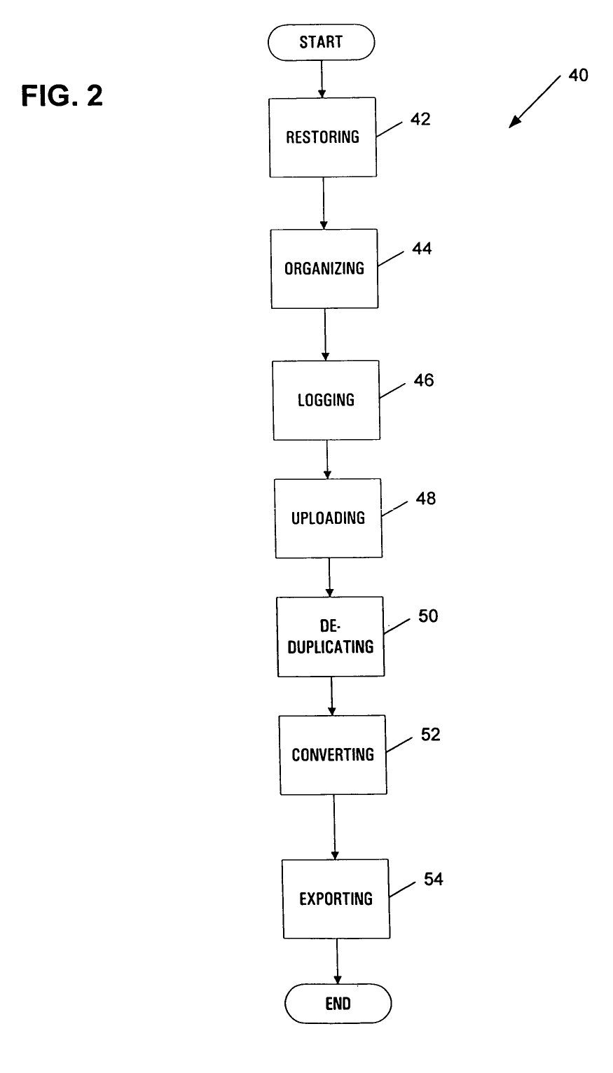

The application of the data management system 20 may include three phases of data processing. Phase 1 is the file logging/uploading/de-duplicating process. Phase 2 is the file converting process. Phase 3 is the file exporting process. The details of three phases are discussed in operational flows shown in FIGS. 2-6.

FIG. 2 illustrates an operational flow 40 of an exemplary data management method in accordance with the principles of the present invention. The operation 40 starts with an operation 42 of restoring a plurality of received data files. The data files can be of different file types. For example, the data files can be Word, JPEG, GIF, Bitmap, Excel, Access, Power Point, text, Adobe Acrobat, Paradox, ZIP files, etc. The data files are then organized/categorized into data slices in an operation 44. Next, in an operation 46, the received data files are logged into a local database formed by the data slice(s). The operation 46 also identifies a file type of the received data files. Then, in an operation 48, the data slice in the local database is uploaded into a global database. The global database stores the information for all data files, their corresponding data slices, the converted image files, flags for the duplicates, flags for encrypted files, etc. The global database is generally a relational database that is known in the computer database art.

Next in an operation 50, the received data files are de-duplicated by calculating a SHA value of the received data files so as to determine whether the received data files have the same SHA value. If the data files have the same SHA value, then the data files are duplicates. If duplicates of the data files are found, they are flagged in the global database. Data files are then converted into image files in an operation 52. The control of the operational flow 40 allows one to have the options of converting the de-duplicated data files, i.e. the data files without deplicates, or converting the data files disregard of the duplicates, i.e. no de-duplicate, or converting a part of de-duplicated data files. Next in an operation 54, the converted image files are exported to a device, e.g. a printer, a viewer program, a PDA (Personal Digital Assistant), etc.

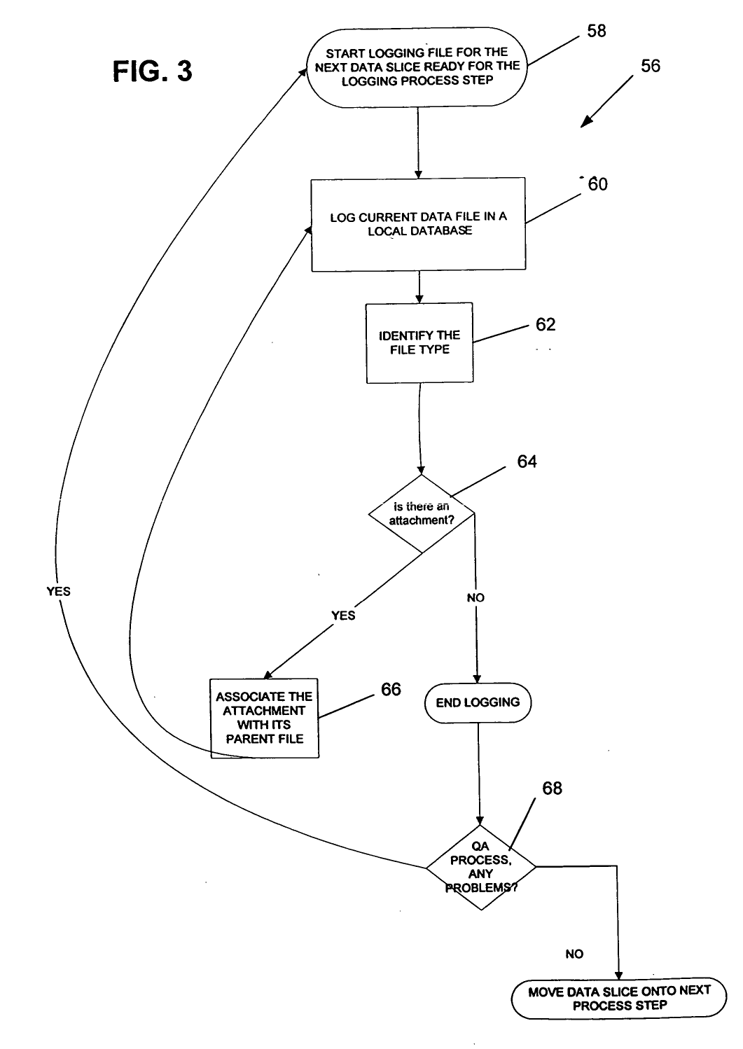

FIG. 3 illustrates an operational flow 56 of logging data files in accordance with the principles of the present invention. The operation 56 starts with an operation 58 of logging/categorizing/organizing data files into data slices. Then, the current data file is logged into a local database in an operation 60. Next, an operation 62 identifies the file type of the data file. Then, an operation 64 determines whether there is an attachment to the current data file. If there is an attachment to the data file, i.e. the “Yes” path, then the attachment is associated with the data file in an operation 66 so that the image files of the attachment can be reviewed with the image files of the data file. The attachment is then further logged into the local database in the operation 60. If there is no attachment to the data file, i.e. the “No” path, then the logging data file operation 56 terminates. A quality & assurance (QA) operation 68 may be launched to determine whether there is any problem in the logging operation 56. If there is a problem, i.e. the “Yes” path, then the operation 56 goes back to start logging the data file or re-logging the data file in the operation 58. If there is no problem, then the data slice moves onto the next process phase.

The QA operation 68 can be implemented in a user interface to the system. The user interface may provide the status of operations in each phase. For example, the user interface may indicate whether the selected or current data file is in a New status, In-Progress status, Done status, Error status, Ignore status, Check/Search status, QA In-Process status, or No Data status, etc.

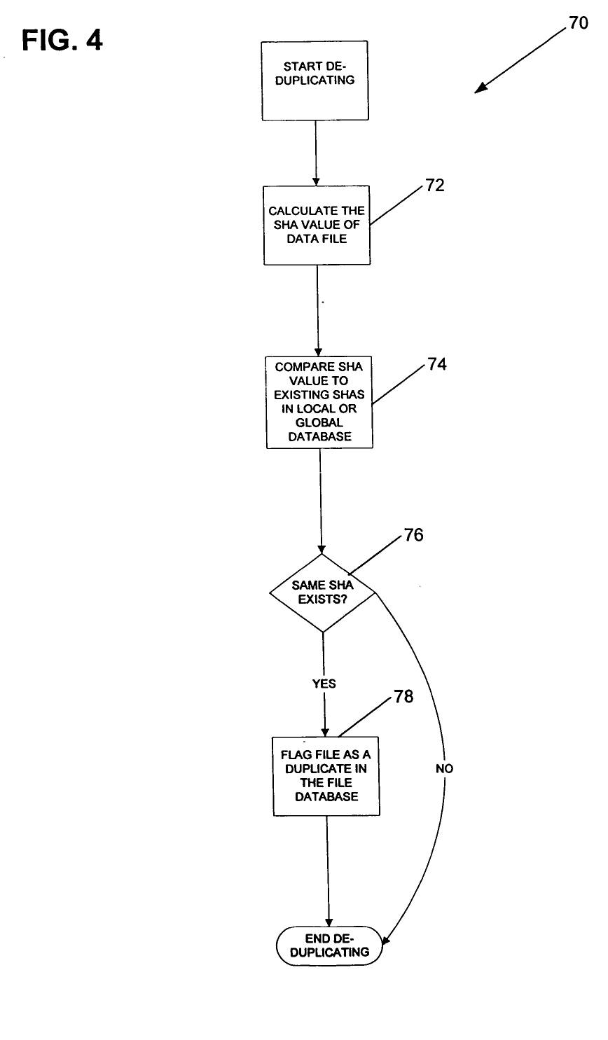

FIG. 4 illustrates an operational flow 70 of de-duplicating data files in accordance with the principles of the present invention. The de-duplicating data file operation 70 starts with an operation 72 of calculating a SHA value for each of the data files. Then, in an operation 74, the SHA values of the data files are compared. The SHA values can be compared to existing SHA values in the local or global database. If the data files have the same SHA value from an operation 76, i.e. the “Yes” path, one of the duplicated data files is retained in the global database, and the other duplicated data files are flagged in the global database in an operation 78. Then, the operation 70 ends. If the data files do not have the same SHA values, the operation 70 ends without flagging.

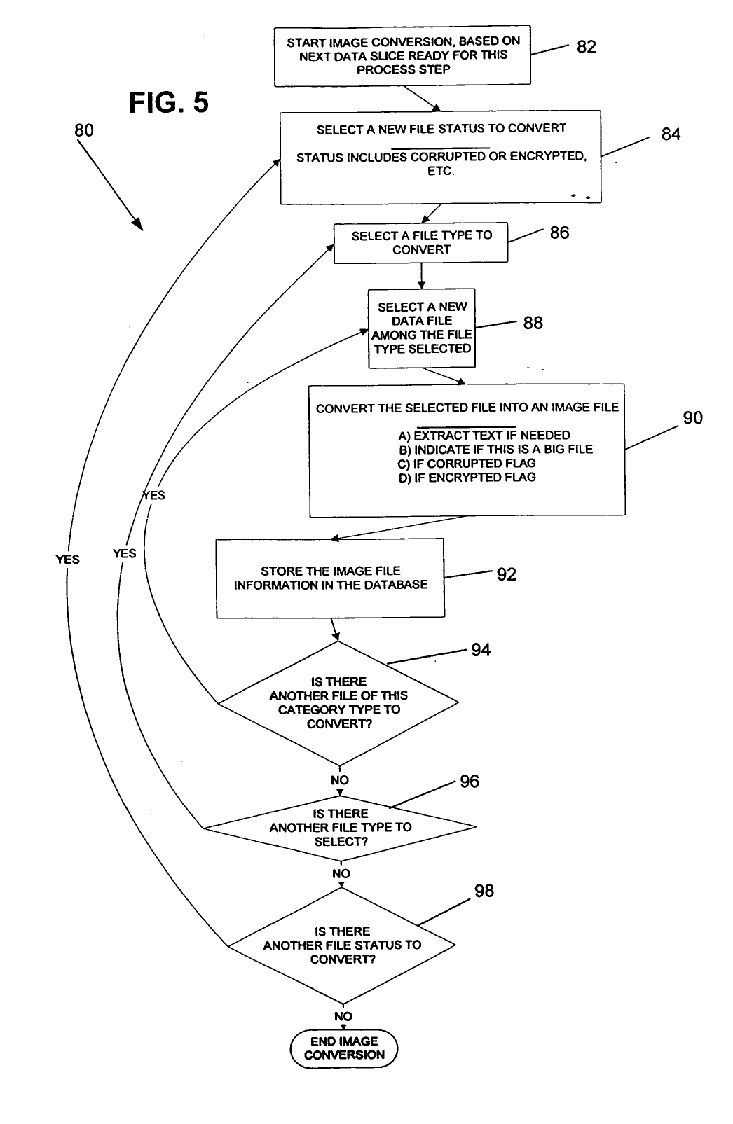

FIG. 5 illustrates an operational flow 80 of image conversion in accordance with the principles of the present invention. An operation 82 starts image conversion based on next data slice ready for this conversion phase. Next, an operation 84 selects a new file status to convert the data files. The file status may include statuses such as New, Corrupted, or Encrypted, etc. Then, an operation 86 selects a file type to convert the data files. Next, an operation 88 selects a new data file. Then, the selected data file is converted into an image file in an operation 90. Also, if extracting text from the data file is needed, the operation 90 flags the text to be extracted. If indication of a big file is desired, the operation 90 flags when the data file exceeds a predetermined size of a file. If the data file is corrupted, the operation 90 flags the data file being corrupted. If the data file is encrypted, the operation 90 flags the data file being encrypted. The corrupted file is generally repaired before converting it to an image file. The encrypted file is generally decrypted before converting it to an image file.

Next, the image file is stored in the global database in an operation 92. Then, an operation 94 determines whether there is another file of this file type category left to convert. If “Yes”, then the operational flow 80 goes to the operation 88 to select a new data file under the selected file type. If “No”, then an operation 96 determines whether there is another file type left to select. If “Yes”, then the operational flow 80 goes to the operation 96 to select a new file type. If “No”, then an operation 98 determines whether there is another file status left to select. If “Yes”, then the operational flow 80 goes to the operation 84 to select a new file status. If “No”, then the image conversion operational flow 80 ends.

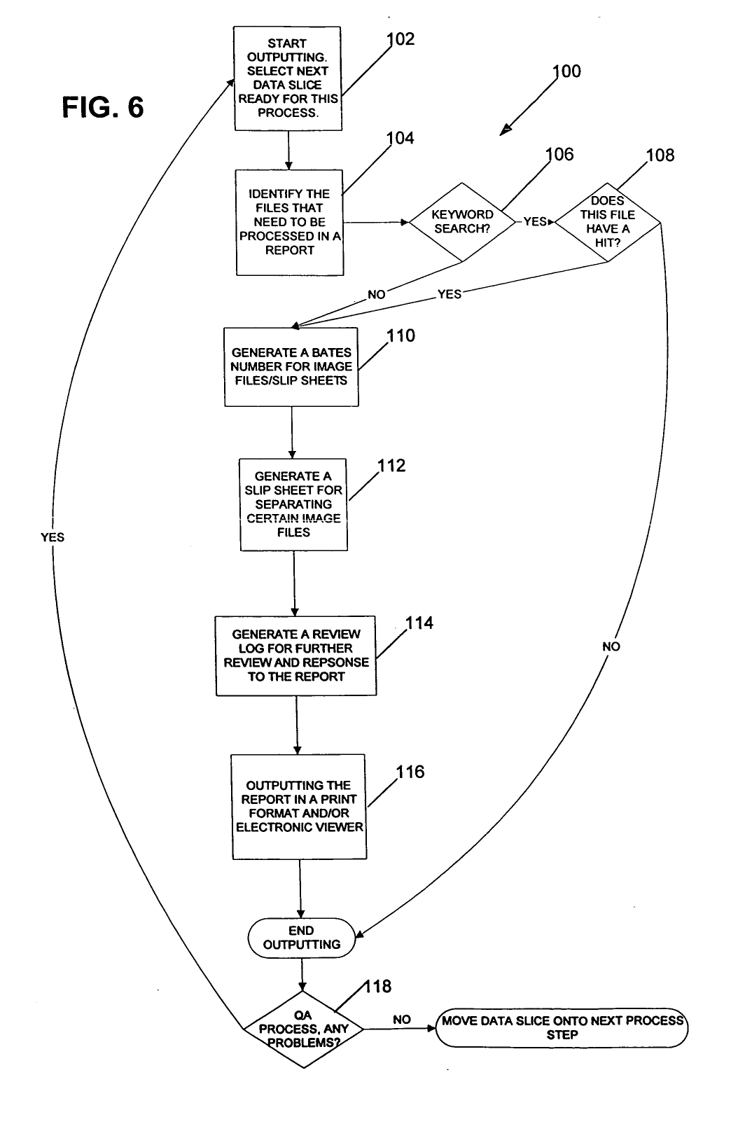

FIG. 6 illustrates an operational flow 100 of outputting image files in accordance with the principles of the present invention. An operation 102 starts outputting the image files of the selected data slice. Then, an operation 104 identifies the file that needs to be processed in a report. Then, the control of the operational flow 100 determines whether a keyword search is desired in an operation 106. If “Yes”, then the keyword search among the image files is performed. An operation 108 determines whether there is a hit after the keyword search. If “Yes”, then an operation 110 generates bates numbers for image files/slip sheets. If “No”, the outputting operational flow 100 ends. If the keyword search is not desired from the operation 106, then bates numbers for image files/slip sheets are generated in the operation 110. Next, slip sheets are generated to separate certain image files in an operation 112. Then, a review log is generated for further review and response to the report in an operation 114. Next, the report is outputted in a print format and/or an electronic viewer in an operation 116. Then, the operational flow 100 ends.

Also shown in FIG. 6 and as described above, a quality and assurance (QA) operation 118 may be launched to determine whether there is any problem in the outputting operation 102. If there is a problem, i.e. the “Yes” path, then the operational flow 100 goes back to start outputting the data file or re-outputting the data file in the operation 102. If there is no problem, then the data slice moves onto the next process.

It is appreciated that the sequence or order of the operational flows 40, 56, 70, 80, and 100 can be varied within the scope of the present invention. Also, it is appreciated that some steps in the operation flows 40, 56, 70, 80, and 100 can be added, merged, and/or eliminated depending on a customer's needs without departing from the scope of the present invention.

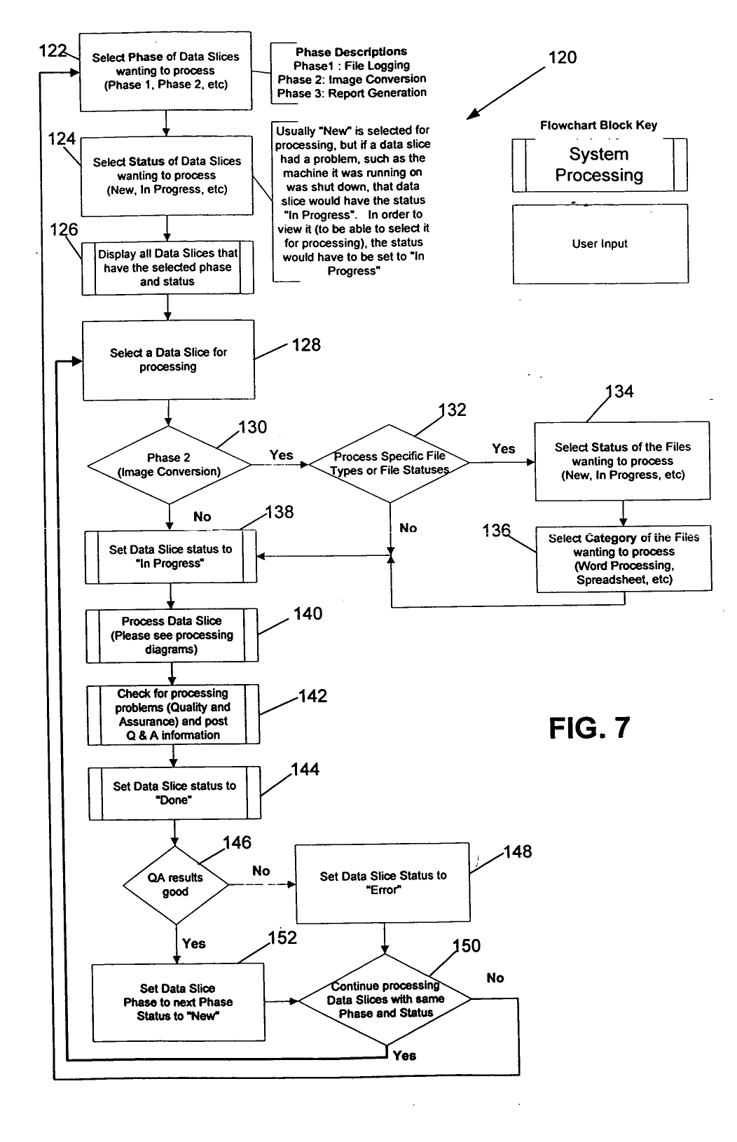

FIG. 7 illustrates a flow diagram 120 representing a specific application of the data management system 20 with exemplary system processing steps and user input steps in accordance with the principles of the present invention In box 122, the user selects the phase of data slices that s/he wants to process, for example, Phase 1, Phase 2, etc. As described above, Phase 1 is a filing logging phase, Phase 2 is an image conversion phase, and Phase 3 is a report generation phase.

In box 124, the user selects the status of data slices that s/he wants to process, for example, New, In Progress, etc. As described above, usually status “New” is selected for processing. If a data slice had a problem, such as the machine it was running on was shut down, etc., that data slice would have the status “In Progress”. In order to view this problematic data slice to select it for processing, the status is set to “In Progress”.

Then, the system displays all data slices that have the selected phase and status as shown in box 126. Next, the user selects a data slice for processing in box 128. If phase 2, i.e. image conversion, is selected from box 130, i.e. “Yes” path, it is determined whether to process specific file types or file status in box 132. If “Yes”, the user selects status (e.g. New. In Progress, etc.) of the files that s/he wants to process in box 134 and selects category or file type (Word Processing, Spreadsheet, etc.) of the files that s/he wants to process in box 136. Then, the system sets the status of the selected data slice to “In Progress” in box 138. If no specific file type or file status is processed from box 132, or if the user does not want to process phase 2, i.e. the image conversion phase, from box 130, the system sets the data slice status to “In Progress” as shown in box 138. Then, the system processes the data slice in box 140 as shown in FIG. 2.

Next, the system checks for processing problems to ensure quality and assurance (QA) and posts QA information in box 142 as described above. Then, the system sets data slice status to “Done” in box 144. The user determines whether the QA results are good in box 146. If “No”, then the system sets data slice status to “Error” in box 148 and determines whether to continue processing data slices with the same phase and status in box 150. If it is to continue, i.e. “Yes” path, then the operational flow 120 goes to the operation 128 to select a data slice for processing. If it is not to continue, i.e. “No” path, then the operational flow 120 goes to the operation 122 to select a phase of data slices that the user wants to process.

If the QA results are good from the box 146, i.e. “Yes” path, then the user sets the data slice Phase to the next Phase Status to “New” in box 152. Then, the operational flow 120 goes to the operation 150 as described above.

It will be clear that the present invention is well adapted to attain the ends and advantages mentioned as well as those inherent therein. While presently preferred embodiments have been described for purposes of this disclosure, various changes and modifications may be made which are well within the scope of the present invention. For example, in FIG. 7, if desired, the steps set by the user may be automatically performed by the system without departing from the scope of the present invention. Numerous other changes may be made which will readily suggest themselves to those skilled in the art and which are encompassed in the spirit of the invention disclosed and as defined in the appended claims.

1. A data management system, comprising:
a first processor for restoring a plurality of received data files, the data files being capable of being different file types;
a file organizing/categorizing processor, coupled to the first processor, for organizing the received data files into data slices, each data slice including an identification number and a descriptor that describes characteristics of the received data file;
a file logging processor, coupled to the file organizing/categorizing processor, for logging the received data files into a first database based on the data slices;
a data uploading processor, coupled to the file logging processor, for uploading the first database to a second database;
a de-duplicate processor, coupled to the data uploading processor, for calculating a SHA value of the received data files to determine whether the received data files have duplicates and flagging duplicated data files in the second database;
an image conversion processor, coupled to the de-duplicate processor, for converting at least a portion of the received data files into image files; and
a second processor, coupled to the image conversion processor, for exporting the image files.

2. The system of claim 1, wherein the first database is a local database for at least one data slice, and the second database is a global database for all logged data slices.

3. The system of claim 1, wherein the image files converted from the data files are in a standardized image format.

4. The system of claim 1, wherein the data files are in a variety of formats including Microsoft Mail, Outlook, GroupWise, Lotus Notes, the user data files have a variety of formats including Word, Excel, PowerPoint, and Access.

5. The system of claim 1, wherein an attachment data file in one of the data files is associated with the data file such that image files for the data file and the corresponding attachment data file are viewed together.

6. The system of claim 1, wherein the file logging processor, the image conversion processor, and the second processor are parallel processors such that the data files are parallel-processed in a data file logging stage, an image conversion stage, and an image file output stage.

7. The system of claim 1, wherein the data files having the same file type are converted into the image files together.

8. The system of claim 1, wherein the data management system includes a plurality of image conversion processors, each of the image conversion processors being capable of converting the data files having the same file type into the corresponding image files.

9. The system of claim 1, wherein the file logging processor identifies the file type of the data files based on the SHA value and a file header of each of the data files.

10. The system of claim 1, further comprising a keyword search processor, coupled to the file logging processor, for searching a keyword from the received data files, wherein if there is a hit, the corresponding data file is retained for processing, and the data file without a hit is discarded without being processed.

11. The system of claim 1, further comprising a keyword search processor, coupled to the image conversion processor, for searching a keyword from the image files, wherein if there is a hit, the corresponding image file is exported, and the image file without a hit is not exported.

12. The system of claim 1, further comprising a file status filter to indicate different statuses of the received data files.

13. The system of claim 12, wherein the different statuses comprise New, In-Progress, Done, Error, Corrupted, Encrypted, No Keyword Hit, Big File, Large Page Count.

14. A data management method, comprising the steps of:
restoring a plurality of received data files, the data files being capable of being different file types;
organizing/categorizing the received data files into data slices, each data slice including an identification number and a descriptor that describes characteristics of the received data file;
logging the received data files into a first database based on the data slices;
uploading the first database to a second database;
de-duplicating duplicates in the received data files by calculating a SHA value of the received data files to determine whether the received data files have duplicates and flagging duplicated data files in the database;
converting at least a portion of the received data files into image files, respectively; and
exporting the image files.

15. The method of claim 14, further comprising the step of viewing the image files stored in the second database.

16. The method of claim 14, wherein the step of converting of the data files comprises the step of converting the data files into a standardized image format.

17. The method of claim 14, further comprising the step of searching a keyword from the received data files, if there is a hit, the corresponding data file is retained for processing, and the data file without a hit is discarded without being processed.

18. The method of claim 14, further comprising the step of searching a keyword from the image files, if there is a hit, the corresponding image file is exported, and the image file without a hit is not exported.
